(19) United States
(12) Patent Application Publication
(10) Pub. No.: US 2026/0173168 A1
(43) Pub. Date: Jun. 18, 2026

(54) RESOURCE SCHEDULING IN MULTIPLE PATHS

(71) Applicant: LENOVO (SINGAPORE) PTE LTD, Singapore (SG)

(72) Inventors: Prateek Basu Mallick, Dreieich (DE); Joachim Lõhr, WIESBADEN, DE (US); Ravi Kuchibhotla, Chicago, IL (US)

(73) Assignee: LENOVO (SINGAPORE) PTE LTD, Singapore (SG)

(21) Appl. No.: 19/125,829

(22) PCT Filed: Nov. 1, 2023
(86) PCT No.: PCT/IB2023/061007

§ 371 Date: Apr. 30, 2025

Related U.S. Application Data
(60) Provisional application No. 63/421,343, filed on Nov. 1, 2022.

(51) Int. Cl. H04W 76/10; H04W 28/02; H04W 72/25; H04W 76/20; H04W 92/18

(52) U.S. Cl. CPC H04W 76/10; H04W 28/0278; H04W 72/25; H04W 76/20; H04W 92/18

(57) ABSTRACT

Various aspects of the present disclosure relate to methods, apparatuses, and systems that support resource scheduling in multiple paths. For instance, implementations provide ways for enabling a user equipment (UE) to obtain sidelink resources and for connection reestablishment in multipath scenarios. In implementations, a UE uses sidelink resources provided by a primary path to a first cell where the UE establishes a radio resource control (RRC) connection until a second link and/or secondary path addition. In scenarios where the primary path is changed to the second path, the UE can start using the sidelink resources provided by a serving cell on the second path.

### RELATED APPLICATION

This application claims priority to U.S. Provisional Application Ser. No. 63/421,343 filed 1 Nov. 2022 entitled “RESOURCE SCHEDULING IN MULTIPLE PATHS,” the disclosure of which is incorporated by reference herein in its entirety.

### TECHNICAL FIELD

The present disclosure relates to wireless communications, and more specifically to resource scheduling in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for providing resources for wireless communications, such as for allocating resources to a UE for wireless transmission. Current wireless communications systems, however, may encounter difficulty when attempting to schedule resources in UE multipath scenarios.

### SUMMARY

The present disclosure relates to methods, apparatuses, and systems that support resource scheduling in multiple paths. For instance, implementations provide ways for enabling a UE to obtain sidelink resources and for connection reestablishment in multipath scenarios. In implementations, a UE uses sidelink resources provided by a primary path to a first cell where the UE establishes a radio resource control (RRC) connection until a second link and/or secondary path addition. In scenarios where the primary path is changed to the second path, the UE can start using the sidelink resources provided by a serving cell on the second path.

By utilizing the described techniques, multipath connectivity implementations are supported which can increase wireless communication reliability and reduce latency in wireless communications.

Some implementations of the methods and apparatuses described herein may further include establishing connectivity with a first radio cell using an indirect path and via a UE-to-network relay, and connectivity with a second radio cell using a direct path; transmitting, to the second radio cell, information pertaining to sidelink transmission to the first radio cell, the information including sidelink UE information and a sidelink buffer status; receiving, from the second radio cell, a first sidelink transmission grant; and transmitting, using the first sidelink transmission grant, sidelink data to the UE-to-network relay.

Some implementations of the methods and apparatuses described herein may further include: establishing the connectivity with the first radio cell before the connectivity with the second radio cell; or establishing the connectivity with the second radio cell before the connectivity with the first radio cell; where establishing connectivity with the first radio cell includes establishing a RRC connection with the first radio cell using the UE-to-network relay; transmitting to the UE-to-network relay using Mode 2 sidelink resources provided by the first radio cell; where the UE-to-network relay includes a first sidelink destination, further including transmitting to a second sidelink destination using Mode 2 resources provided by the first radio cell; receiving RRC reconfiguration from the first radio cell configuring radio measurements; and transmitting, to the first radio cell, radio measurements based at least in part on the RRC reconfiguration; where establishing the connectivity with the second radio cell includes receiving RRC reconfiguration from the first radio cell for establishing the connectivity with the second radio cell.

Some implementations of the methods and apparatuses described herein may further include: where the first sidelink transmission grant from the second radio cell includes a Mode 1 sidelink transmission grant; receiving sidelink resources via one or more of system information or dedicated RRC signaling; and transmitting to the UE-to-network relay using the sidelink resources; where the sidelink buffer status includes a data volume of one or more logical channels of the UE-to-network relay; transmitting data of at least one Uu application via the UE-to-network relay for receipt by the first radio cell; determining that sidelink resources associated with the first radio cell and the second radio cell are concurrently usable for sidelink transmission; receiving, from the first radio cell, a second sidelink transmission grant; transmitting a first data type using the first sidelink transmission grant; and transmitting a second data type using the second sidelink transmission grant; receiving, from one or more of the UE-to-network relay or the second radio cell, reestablishment information indicating which of the first radio cell or the second radio cell is to be used for a connection reestablishment procedure; and implementing, based at least in part on a reestablishment event, the connection reestablishment procedure based at least in part on the reestablishment information.

Some implementations of the methods and apparatuses described herein may further include receiving, at a first radio cell and from a first UE, information pertaining to sidelink transmission to a second radio cell, the information including sidelink UE information and a sidelink buffer status of the first UE; and transmitting, to the first UE, a sidelink transmission grant including sidelink resources for sidelink transmission to the second radio cell.

Some implementations of the methods and apparatuses described herein may further include where the sidelink transmission grant includes a Mode 1 sidelink transmission grant; where the sidelink buffer status includes a data volume of one or more logical channels of a UE-to-network relay used by the first UE for transmission to the second radio cell.

Some implementations of the methods and apparatuses described herein may further include establishing connectivity with a first radio cell using an indirect path and via a UE-to-network relay, and connectivity with a second radio cell using a direct path; receiving, from one or more of the UE-to-network relay or the second radio cell, reestablishment information indicating which of the first radio cell or the second radio cell is to be used for a connection reestablishment procedure; and implementing, based at least in part on a reestablishment event, the connection reestablishment procedure based at least in part on the reestablishment information.

Some implementations of the methods and apparatuses described herein may further include where the reestablishment event includes one or more of a radio link failure, a notification from the UE-to-network relay, or a unicast link release; where implementing the connection reestablishment procedure includes: selecting, based at least in part on the reestablishment information, a reestablishment cell from the first radio cell and the second radio cell; and utilizing, as part of the connection reestablishment procedure, credentials associated with the reestablishment cell; where the credentials associated with the reestablishment cell include one or more of a cell radio network temporary identifier (C-RNTI) of the reestablishment cell or a physical cell identity of the reestablishment cell.

### BRIEF DESCRIPTION OF THE DRAWINGS

FIG. 1 illustrates an example of a wireless communications system that supports resource scheduling in multiple paths in accordance with aspects of the present disclosure.

FIG. 2 illustrates an example system for multipath connectivity.

FIG. 3 illustrates an example information element (IE) that can be utilized in scenarios for connection reestablishment.

FIG. 4 illustrates an example user plane protocol stack for multi-path connectivity.

FIG. 5 illustrates an example control plane protocol stack for multi-path connectivity.

FIG. 6 illustrates an example user plane protocol stack for multi-path connectivity.

FIG. 7 illustrates an example control plane protocol stack for multi-path connectivity.

FIG. 8 illustrates a system that supports resource scheduling in multiple paths in accordance with aspects of the present disclosure.

FIGS. 9 and 10 illustrate examples of block diagrams of devices that support resource scheduling in multiple paths in accordance with aspects of the present disclosure.

FIGS. 11 through 14 illustrate flowcharts of methods that support resource scheduling in multiple paths in accordance with aspects of the present disclosure.

### DETAILED DESCRIPTION

In wireless communications systems, UE-to-network relay and UE-to-UE relay has been discussed, such as for V2X, public safety, commercial applications and services, and so forth. However, current proposals are limited in term of implementation details. For instance, support of UE-to-UE relay has not been addressed, which is essential for sidelink coverage extension without relying on the use of uplink and downlink. Service continuity enhancements in UE-to-Network relay are also important to cover certain mobility scenarios.

Further, support of multipath with relay has been suggested where a remote UE is connected to a network via direct and indirect paths. Multipath relay, for instance, can be utilized for UE aggregation where a UE is connected to a network via a direct path and via another UE using a UE-UE interconnection. Some current wireless communications systems, however, fail to provide for certain multipath scenarios and particularly for provision of sidelink resources by different serving cells in multipath scenarios. For instance, in current wireless communications systems it is unclear in multipath implementations if a UE is to continue to use the sidelink resources from an old PCell or a new PCell where the PCell of the UE is moved to a different link.

Accordingly, this disclosure provides for techniques that support resource scheduling in multiple paths. For instance, implementations provide ways for enabling a UE to obtain sidelink resources and for connection reestablishment in multipath scenarios. In implementations, a UE uses sidelink resources provided by a primary path to a first cell where the UE establishes an RRC connection until a second link and/or secondary path addition. In scenarios where the primary path is changed to the second path, the UE can start using the sidelink resources provided by a serving cell on the second path.

In implementations, a UE can continue to use the sidelink transmission resources currently in use, e.g., irrespective of a second link and/or secondary path addition.

In implementations, a UE can use sidelink resources provided in broadcast signaling (e.g., SIB12) for transmission by one or more serving cells (e.g., a cell connected via direct connectivity and/or a cell connected via indirect connectivity, such as discussed below) until a dedicated sidelink resource configuration (e.g., sl-ConfigDedicatedNR) is received. Further, RRC signaling can be used to indicate which cell's sidelink resources is to be used or if both cell's sidelink resources can be used for providing sidelink resources.

In implementations, such as by way of specification and/or RRC configuration, a UE can use Mode 2 sidelink resources of one cell to transmit data of certain data type(s) and other sidelink data can be sent using sidelink resources provided by another cell. Various implementations are also provided to for a UE to report sidelink buffer status to a first cell on a direct link, providing flexibility to the UE to schedule some sidelink data transmission using Mode 2 resources of a second cell, e.g., a second cell to which the UE is connected via an indirect link. For mobility scenarios (e.g., PCell change), a UE can use sidelink resources provided in broadcast signaling (e.g., SIB12) of a cell to which the UE is connected via an indirect link.

According to implementations for connection reestablishment procedures, implementations can indicate to a UE which cell is to be used as the source cell and which C-RNTI to be used as reestablishment identity and therefore is to be used in the calculation of security input (e.g., ShortMAC-Input). For instance, this information can be provided as:
i) explicitly indicated to the UE using RRC signaling;
ii) UE is to set the identities based on the PCell at the point in time of occurrence of radio link failure, handover failure message, receiving PC5 unicast link release indicated by upper layer, etc.

Thus, by utilizing the described techniques, multipath connectivity implementations are supported which can increase wireless communication reliability and reduce latency in wireless communications.

Aspects of the present disclosure are described in the context of a wireless communications system. Aspects of the present disclosure are further illustrated and described with reference to device diagrams and flowcharts.

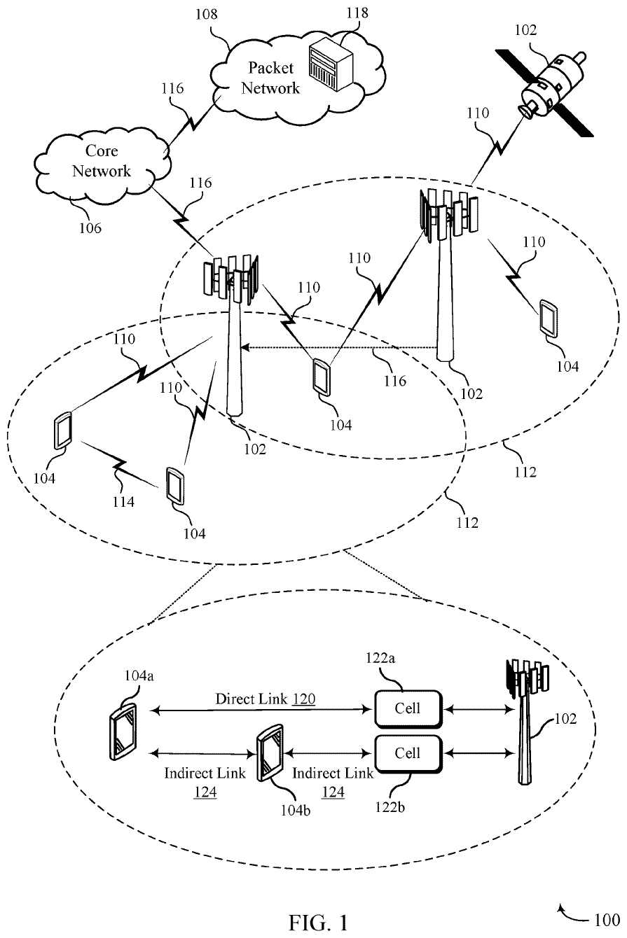

FIG. 1 illustrates an example of a wireless communications system 100 that supports resource scheduling in multiple paths in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., RRC, service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for resource scheduling in multiple paths, a UE 104a can establish multipath connectivity with a network entity 102. For instance, the UE 104a can establish a direct link 120 to a cell 122a of the network entity 102. Further, the UE 104a can establish an indirect link 124 to a cell 122b of the network entity 102 and using a UE 104b as a relay node to the cell 122b. The UE 104a, for instance, can participate in sidelink communication with the UE 104b to transmit data, which the UE 104b can transmit to the cell 122b. In implementations, the UE 104a can maintain the direct link 120 and the indirect link 124 concurrently, such as for concurrent multipath connectivity to the network entity 102. Further, resources utilized by the UE 104a (e.g., sidelink resources) can be allocated via the direct link 120 and/or the indirect link 124.

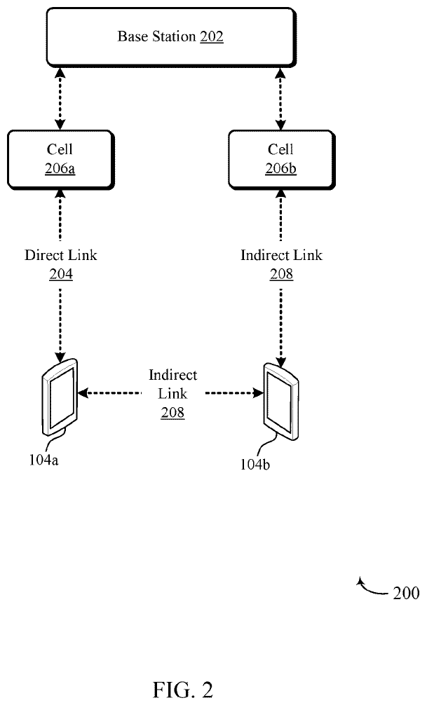

FIG. 2 illustrates an example system 200 for multipath connectivity. The system 200 includes a remote UE 104a that is connected to a base station 202 (e.g., a gNB) via a direct link 204 to a cell 206a of the base station 202. The UE 104a is also connected to the base station 202 via an indirect link 208 to a cell 206b of the base station 202. The indirect link 208, for instance, uses a UE 104b as a relay UE for connecting the UE 104a to the cell 206b. In at least one implementation the UE 104a transmits data to and receives data from the UE 104b via sidelink connectivity (e.g., PC5 connectivity) to the UE 104b. Further, the cells 206a, 206b can represent different distributed units (DU) and the base station 202 can represent a centralized unit (CU). In at least some implementations, system information, including SIB12 carrying sidelink resource configuration, can be signaled to the UE 104a using the direct link 204 and/or the indirect link 208.

In some wireless communications systems, a sidelink transmitter may be provided with sidelink resources from one cell, e.g., a primary cell (PCell). Thus, for sidelink scheduling particularly in multipath scenarios, a consideration is how sidelink resources are allocated, such as via a direct link and/or an indirect link, either of which can be considered as a primary path.

In scenarios such as radio link failure (RLF) on one link, repeated listen before talk (LBT) failures, and/or based on radio geometry, sidelink resource allocation and/or scheduling is preferably flexible. For instance, where a remote UE in a multipath scenario using a UE to network (U2N) relay has Uu coverage available from multiple cells (e.g., as illustrated in the system 200), sidelink resource allocation and/or scheduling strategies are disclosed herein. A further consideration is that if RLF occurs on a link and/or repeated LBT failures occur, whether a UE can use an exceptional resource from one link or use Mode 1 or Mode 2 scheduling from another link. A further consideration is that in normal operation in a multipath scenario using a U2N relay and direct connectivity (e.g., as in the system 200), which of the two cells is to schedule sidelink resources is a consideration. In implementations, where Mode 1 resource allocation from one cell and Mode 2 resource allocation from another cell can be used together, an improved buffer status reporting may provide a network with enhanced information regarding a UE's buffer status which may allow the UE to flexibly use Mode 2 based resource allocation.

In some scenarios an RLF can occur in any particular link in a multipath scenario. For instance, with reference to the system 200, RLF on the indirect link 208 can occur due to a RLF on the PC5 interface between the UE 104a and the UE 104b and/or an RLF on the Uu interface between the UE 104b (e.g., the U2N relay UE) and its serving cell 206b. In some scenarios, the UE 104a may trigger RRC reestablishment based on RLF on the direct link 204. Further, the direct link 204 may be subject to reconfiguration, e.g., a network may change to the direct link 204 from an earlier primary path on the indirect link 208, or vice-versa. In such scenarios that occur in some wireless communications systems, which cell may have been used as the source cell and which C-RNTI to be used as a reestablishment identity and therefore is to be used in the calculation of security input (e.g., ShortMAC-Input), may not be known to the UE 104a, e.g., since the UE 104a may not know when the base station 202 initiated preparing candidate cells for handover and/or connection reestablishment.

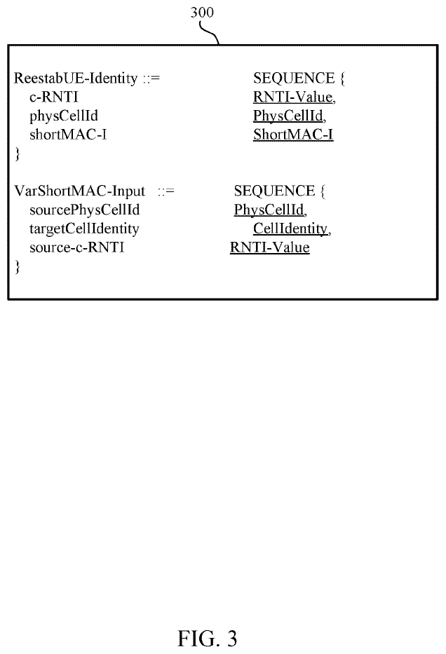

FIG. 3 illustrates an example information element (IE) 300 that can be utilized in scenarios for connection reestablishment.

While the system 200 detailed above is discussed with reference to the cells 206a, 206b terminating at the same base station 202, in scenarios for multipath sidelink relaying, cells may belong terminate with different base stations, e.g., different gNBs. Further, implementations may utilize more than one relay UE to relay the remote UE's data towards further cells belonging to same and/or different base station. In implementations described herein, an indirect link can be used to represent each indirect link, such as where more than one indirect link is configured to the remote UE (e.g., the UE 104a) in a multipath connection.

Implementations disclosed here are applicable to multiple scenarios, including:
1) Scenario 1: U2N Relay UE provides an indirect link; and
2) Scenario 2: Another UE (e.g., used for aggregation, using a non-standardized UE-UE interconnection) provides an indirect link.

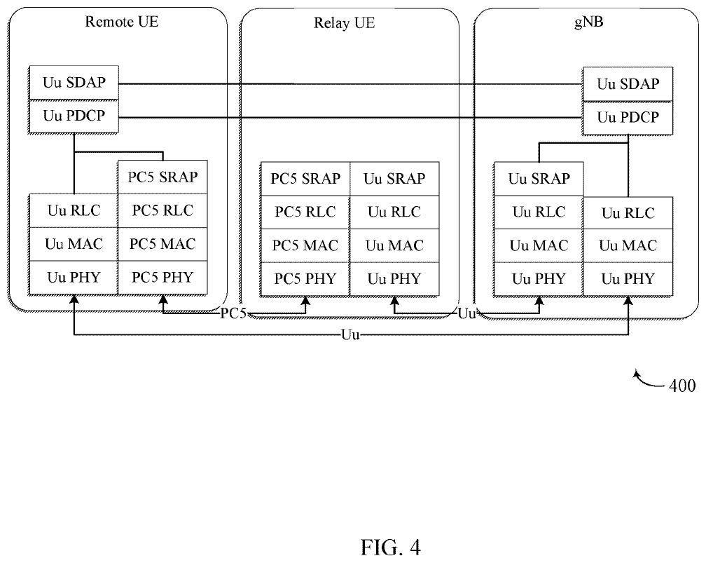

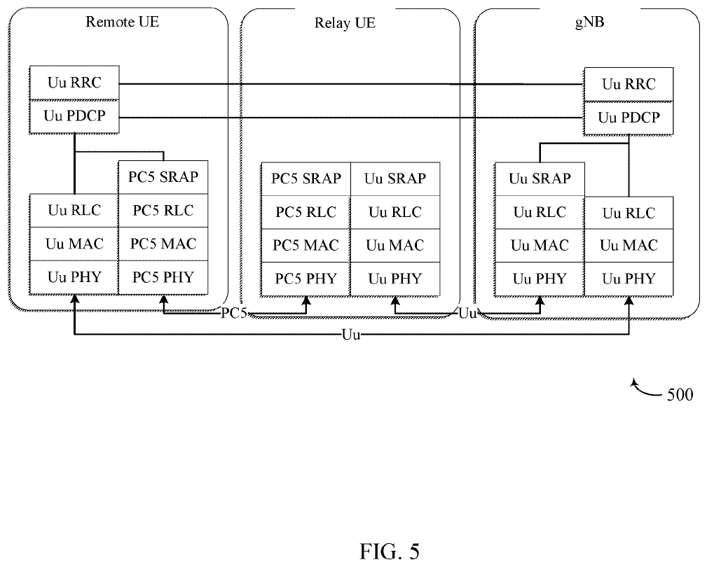

FIG. 4 illustrates an example user plane protocol stack 400 for multi-path connectivity. The user plane protocol stack 400, for instance, can be used as part of Scenario 1. FIG. 5 illustrates an example control plane protocol stack 500 for multi-path connectivity. The control plane protocol stack 500, for instance, can be used as part of Scenario 1.

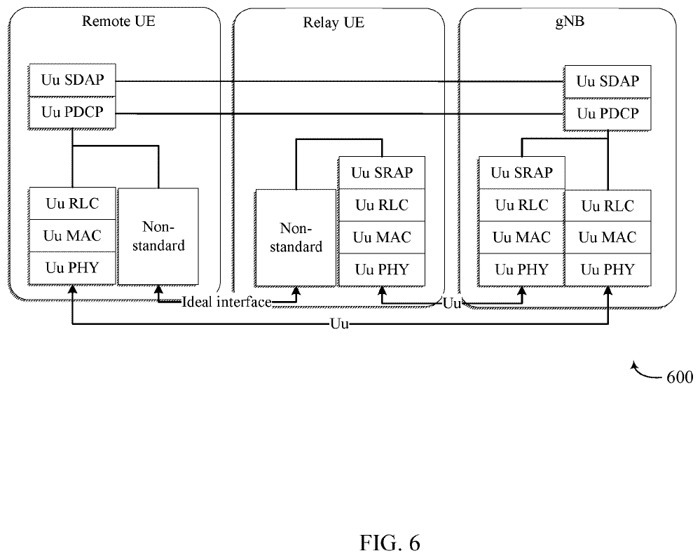

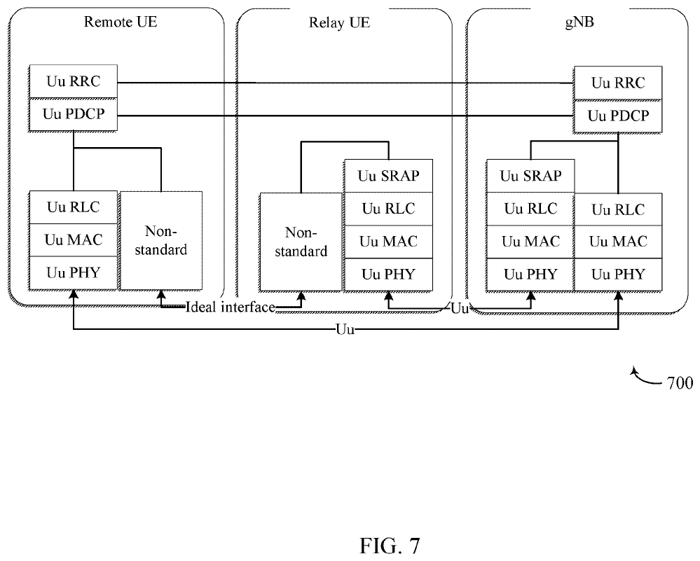

FIG. 6 illustrates an example user plane protocol stack 600 for multi-path connectivity. The user plane protocol stack 600, for instance, can be used as part of Scenario 2. FIG. 7 illustrates an example control plane protocol stack 700 for multi-path connectivity. The control plane protocol stack 700, for instance, can be used as part of Scenario 2. In implementations for Scenario 2, the interface between a remote UE and a relay UE is ideal and the relay UE can be used as an additional resource to transfer the remote UE's data.

According to implementations, two resource allocation modes can be used for NR sidelink communication, referred as Mode 1 and Mode 2. Mode 1 and Mode 2, for instance, support direct sidelink (SL) communications but differ on how they allocate the radio resources. Mode 1 Resources can be allocated by the cellular network, e.g., gNB. Mode 2 based SL resource selection does not require cellular coverage, and a UE can autonomously select radio resources, such as using a distributed scheduling scheme supported by congestion control mechanisms from pre-configured resource pools. Mode 2 resources can also be allocated by the RAN for in-coverage UEs using broadcast and/or dedicated RRC signaling. In scenarios, Mode 2 can be considered a baseline mode and represents an alternative to 802.11p or dedicated short range communications (DSRC). Implementations described herein can be implemented according to the scenarios described above. Further, implementations described below are discussed in the context of the systems 100, 200, but may be implemented in a variety of different systems and/or scenarios.

In some wireless communications systems, a UE 104a may use sidelink resources (e.g., perform resource selection for transmission) provided in broadcast signaling (e.g., SIB12) by a cell with which the UE 104a had a first link established. For instance, if a dedicated sidelink resource configuration (e.g., sl-ConfigDedicatedNR) is received, the UE 104a can use dedicated sidelink resource configuration until further RRC reconfiguration containing sl-ConfigDedicatedNR or until the primary path and/or PCell is changed, in which case the UE 104a may use sidelink resources provided in SIB12 of the target cell. Accordingly, in implementations where a dedicated sidelink resource configuration (e.g., sl-ConfigDedicatedNR) is not included in the reconfiguration initiating the change of a primary path/PCell, the target cell can be the radio serving cell when the indirect path served as primary path (e.g., PCell of the U2N relay), or the target cell can be the PCell of the U2N relay when the direct path served as primary path—e.g., before a primary path/PCell change procedure.

As an example, if the UE 104a had the direct link 204 established before the indirect link 208, the cell 206a can schedule sidelink resources to the UE 104a for transmissions including to transmit discovery (e.g., Announcement or Solicitation) messages. The cell 206a may use Mode 1 (e.g., network scheduled) or Mode 2 (e.g., UE scheduled) resource allocation for this purpose. After a change of the primary path, sidelink resources provided by the cell 206b can be used.

As another example, if the UE 104a had the indirect link 208 established before the direct link 204 addition, the cell 206b schedule sidelink resources to the remote UE 104a for transmissions including to transmit discovery (e.g., Announcement or Solicitation) messages. The cell 206b may use Mode 2 (e.g., UE scheduled) resource allocation for this purpose. After change of the primary path, sidelink resources provided by the cell 206a can be used.

In implementations, the UE 104a can continue to use the sidelink transmission resources currently in use, irrespective of a second link and/or secondary path addition. In implementations, the UE 104a can use the sidelink resources provided by a first cell (e.g., link) where the UE 104a establishes an RRC connection until a second link and/or secondary path addition. If the primary path is changed to a second path, the UE 104a can start using the sidelink resources provided by serving cell on the second path.

According to additional or alternative implementations, the UE 104a can use sidelink resources provided in broadcast signaling (e.g., SIB12) for transmission by one or both of the serving cells (e.g., cells 206a, 206b) until a dedicated sidelink resource configuration (e.g., sl-ConfigDedicatedNR) is received. In an implementation, which cell's sidelink resources to be used or if both cell's sidelink resources can be used can be configured to the UE 104a, e.g., using RRC signaling.

In implementations, to receive SIB12 of a serving cell of the U2N relay, the UE 104a may use a dedicated system information block (SIB) request procedure used by RRC connected UEs for requesting SIB12 and/or a SIB including sidelink resource information broadcast by the serving cell of a U2N relay to the serving cell on the direct path.

Implementations also provide for which cell's (e.g., which of cell 206a, 206b) sidelink resources can be used for which purpose (which kind of SL data) when using Mode 2 based sidelink resource scheduling. The following represent different types of sidelink data that can be transmitted by the UE 104a:
data that is to be sent to a gNB (e.g., the base station 202) and is configured to be carried in an indirect bearer, e.g., a bearer configured on the indirect link 208 (data type-a);
data that is to be sent to a gNB (e.g., the base station 202) and is configured to be carried in a split bearer, e.g., data from the application is to be carried in a direct Uu link as well as in the indirect link/path (data type-b);
sidelink data that is for the U2N sidelink relay (e.g., the UE 104b). For instance, the UE 104b does not forward this data on the Uu interface to its serving cell, e.g., the cell 206b (data type-c);
sidelink data that is for another sidelink UE, e.g., the UE 104b and/or other UE acts also as a UE-to-UE relay and forwards this data on the sidelink interface to a destination sidelink remote UE (data type-d).

In implementations, such as according to specification and/or RRC configuration, the UE 104a can use Mode 2 sidelink resources of one cell to transmit data of certain data type(s) mentioned above. For instance, cell 206a Mode 2 sidelink resources can be used for data type-a and data type-b, and other sidelink data can be sent using sidelink resources provided by cell 206b.

In implementations such as based on Mode 1 sidelink resource scheduling, buffer status reporting can be implemented to receive sidelink and uplink grants from the network, e.g., cell 206a. Accordingly, the UE 104a can transmit a Uu Buffer Status Report MAC control element (CE) and/or Sidelink Buffer Status Report MAC CE to its serving cell.

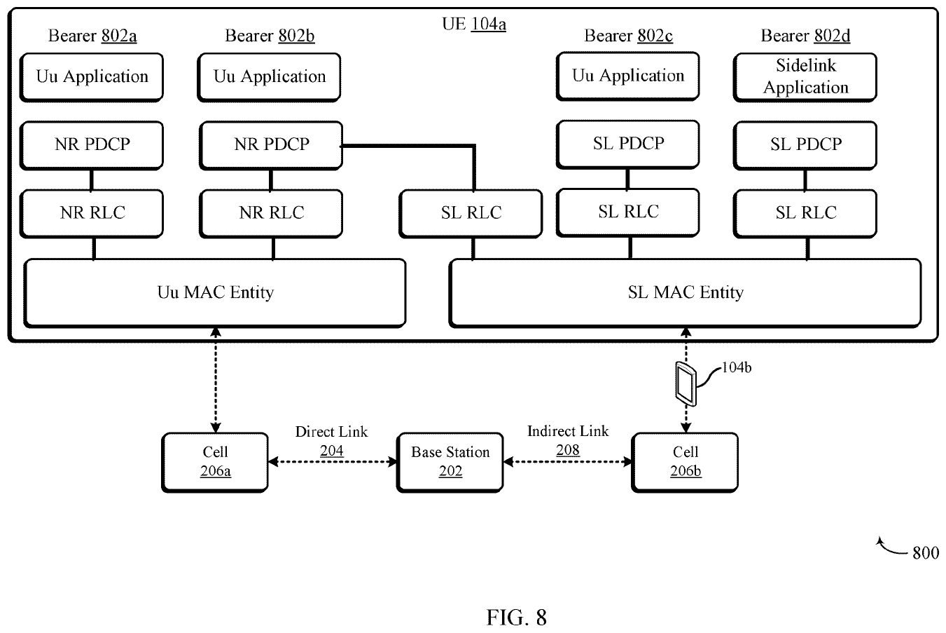

FIG. 8 illustrates a system 800 that supports resource scheduling in multiple paths in accordance with aspects of the present disclosure. The system 800, for instance, illustrates different bearers 802 (e.g., radio bearers) that can be used by the UE 104a to transmit and receive data. In implementations: a bearer 802a uses Uu resources of the cell 206a; a bearer 802b is a split bearer and the UE 104a may use both Uu and SL resources via the bearer 802b; a bearer 802c can be dedicated by the UE 104a for sidelink resources; and a bearer 802d can terminate in another SL device, e.g., a U2N relay (e.g., the UE 104b) and/or other SL UE.

In implementations, for the bearer 802b a sidelink buffer status report MAC CE includes a data volume from the SL RLC entity but not from the NR PDCP entity. Accordingly, an ensuing sidelink buffer status report MAC CE can be sent to the cell 206a. The data volume at the NR PDCP (e.g., as defined in Ch. 5.6 of 3GPP Technical Specification 38.323) for the bearer 802b can be reported to cell 206a using a Uu buffer status report MAC CE.

In implementations, a portion of the data volume in the NR PDCP can be assumed to be scheduled by the UE 104a itself, e.g., using Mode 2 resources. Thus, this data volume may be deducted from the data volume to be reported to the cell 206a in a Uu buffer status report MAC CE. How many bytes long the portion of the data volume in the NR PDCP assumed to be scheduled by the UE itself may depend on different factors such as a SL configured grant available at the UE 104a, channel busy ratio (CBR) of the channel between remote and U2N relay UE, etc.

In implementations, data volume (e.g., data volume at the PDCP and RLC entity) from the bearer 802c and/or the bearer 802d may be reported in a sidelink buffer status report MAC CE to the cell 206a and/or the UE 104a may decide to use Mode 2 resource allocation for one or both of the bearer 802c and/or the bearer 802d. In such scenarios the UE 104a may not report the corresponding data volume to the cell 206a.

In implementations, data volume from bearers 802b, 802c, and/or 802d may be reported in a sidelink buffer status report MAC CE to the cell 206a. This may provide the cell 206a with comprehensive information when the remote UE 104a does not intend to use Mode 2 based resource selection and/or when Mode 2 resources are not scheduled by the cell 206a and/or the cell 206b.

In implementations, the data volume from bearers 802b, 802c, and/or 802d may not be reported in its entirety to the cell 206a but rather only a fraction of the total data volume can be reported. As one example, the reported data volume equals a total data volume deducting the data volume intended to be transmitted using Mode 2 resource allocation by the UE 104a itself.

Implementations also enable mobility situations. For instance, when a PCell change happens such that the cell 206a is replaced with another cell (e.g., a cell-3, not shown), the UE 104a can use sidelink resources provided in broadcast signaling (e.g., SIB12) of the cell 206b and/or dedicated sidelink resource configuration (e.g., sl-ConfigDedicatedNR) if provided by the cell 206b, instead of exceptional sidelink resources (sl-TxPoolExceptional) provided by the cell 206a or cell-3 using RRC signaling.

Implementations described herein also enable triggering of RRC connection reestablishment procedures. For instance, with reference to the system 200, an RLF can occur in any of the two links of the RRC connected sidelink UE 104a in the multipath scenario, and reconfiguration with sync failure may occur when changing the PCell (e.g., the cell 206a) to another cell, e.g., cell-3. RLF on the second link, for instance, can occur due to a RLF on the PC5 interface between the UE 104a and the UE 104b, a RLF on the Uu interface between the UE 104b and the cell 206b, etc. The remote UE 104a, however, may be constrained to triggering the RRC reestablishment based on RLF on the direct link 204. The direct link 204, for instance, may be subject to reconfiguration, e.g., the network may change the primary path to be the direct link 204 from an earlier primary path on the indirect link, or vice-versa. In such scenarios, which cell may have been used as the source cell and which C-RNTI to be used as reestablishment identity and therefore should be used in the calculation of security input (e.g., ShortMAC-Input) may not be known to the UE 104a since the UE 104a may not know when the serving gNB started preparing candidate cells for handover and/or connection reestablishment.

In implementations the IE 300 illustrated in FIG. 3 supports resource scheduling in multiple paths in accordance with aspects of the present disclosure. With reference to the system 200, each of the cells 206a, 206b may provide its own c-RNTI to the UE 104a and the physical cell identities of the cells 206a, 206b are different. Accordingly, each of the cells 206a, 206b may utilize IE 300 for this purpose.

The following implementations can be applied in the following scenarios additionally or alternatively to RLF. For instance, if RLF and/or one or more of the following scenarios occurs, a UE may receive information from the network informing the UE which cell credentials apply when RLF and/or other event occurs and reestablishment is to be implemented:
upon detecting sidelink radio link failure by L2 U2N Remote UE in RRC_CONNECTED;
upon reception of a notification message (NotificationMessageSidelink including indicationType) from the relay UE by L2 U2N Remote UE in RRC_CONNECTED;
upon PC5 unicast link release indicated by upper layer at L2 U2N Remote UE in RRC_CONNECTED.

In implementations, information about which serving cell (e.g., cell 206a or cell 206b) has been selected to be used for handover and/or reestablishment preparation can be indicated to the UE 104a using RRC signaling, e.g., as the selected source cell for reestablishment (“selected cell”). The UE 104a can then use the credentials corresponding to the signaled selected cell for reestablishment purposes. For instance, when a procedure is initiated due to RLF and/or reconfiguration with sync failure, the UE 104a can set the reestablishment Cell Id (e.g., reestablishmentCellId) in a variable (e.g., VarRLF-Report) to a global cell identity of the selected cell and set the ue-Identity as follows:
set the c-RNTI to the C-RNTI used in the selected cell
set the physCellId to the physical cell identity of the selected cell

In implementations, the security input (e.g., shortMAC-I) can be set to the 16 least significant bits of the MAC-I calculated using the said source Physical Cell ID (sourcePhysCellId) set to the physical cell identity of the selected cell, source C-RNTI (source-c-RNTI) set the c-RNTI to the C-RNTI used in the selected cell and the target cell identity.

In implementations, a network prepares neighbor cells for a possible handover and/or reestablishment procedure indicating both cell 206a and cell 206b to be possible source cells. The Xn signaling for this purpose can be achieved by having two separate procedures where both cells prepare neighbor cells independently or, in one combined procedure and indicating that either of the cell 206a or the cell 206b credential may be used by the UE 104a for reestablishment. The C-RNTI and physical cell identity of each of these two cells can be provided to the neighbor cells for preparation purposes. The UE 104a can set the ue-identity and calculate the security input (e.g., shortMAC-I) based on the PCell at the point in time of RLF and/or handover failure message or receiving PC5 unicast link release indicated by upper layer information.

In implementations the UE 104a uses the credentials (e.g., C-RNTI allocated by and Physical cell identity of) of the current PCell, where instances of the previously mentioned events (e.g., RLF, reception of a notification message or PC5 unicast link release indicated by upper layer, etc.) occur for the reestablishment purpose. In implementations this can occur irrespective of which path is configured as the primary path at a moment of occurrence of an instance of these events.

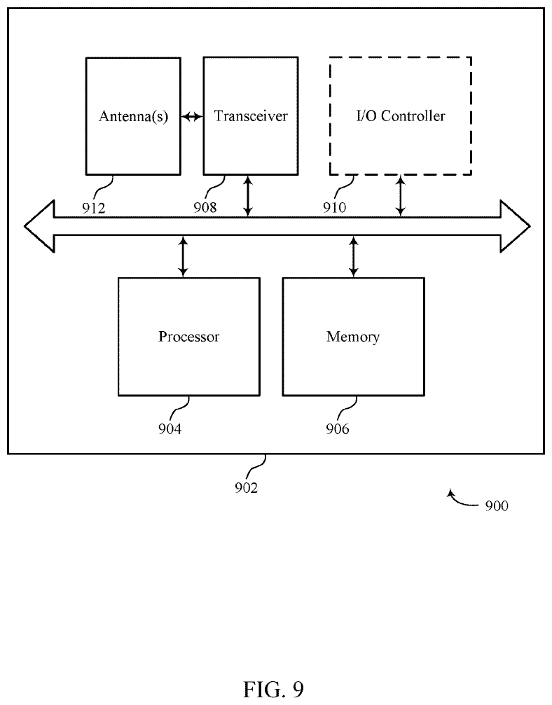

FIG. 9 illustrates an example of a block diagram 900 of a device 902 (e.g., an apparatus) that supports resource scheduling in multiple paths in accordance with aspects of the present disclosure. The device 902 may be an example of UE 104 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906). In the context of UE 104, for example, the transceiver 908 and the processor coupled 904 coupled to the transceiver 908 are configured to cause the UE 104 to perform the various described operations and/or combinations thereof.

For example, the processor 904 and/or the transceiver 908 may support wireless communication at the device 902 in accordance with examples as disclosed herein. For instance, the processor 904 and/or the transceiver 908 may be configured as and/or otherwise support a means to establish connectivity with a first radio cell using an indirect path and via a UE-to-network relay, and connectivity with a second radio cell using a direct path; transmit, to the second radio cell, information pertaining to sidelink transmission to the first radio cell, the information including sidelink UE information and a sidelink buffer status; receive, from the second radio cell, a first sidelink transmission grant; and transmit, using the first sidelink transmission grant, sidelink data to the UE-to-network relay.

Further, in some implementations, the processor is configured to cause the apparatus to:
establish the connectivity with the first radio cell before the connectivity with the second radio cell;
and establish the connectivity with the second radio cell before the connectivity with the first radio cell; to establish connectivity with the first radio cell, the processor is configured to cause the apparatus to establish a RRC connection with the first radio cell using the UE-to-network relay; the processor is configured to cause the apparatus to transmit to the UE-to-network relay using Mode 2 sidelink resources provided by the first radio cell; the UE-to-network relay includes a first sidelink destination, and wherein the processor is configured to cause the apparatus to transmit to a second sidelink destination using Mode 2 resources provided by the first radio cell; the processor is configured to cause the apparatus to: receive RRC reconfiguration from the first radio cell configuring radio measurements for the apparatus; and transmit, to the first radio cell, radio measurements based at least in part on the RRC reconfiguration; to establish the connectivity with the second radio cell, the processor is configured to cause the apparatus to receive RRC reconfiguration from the first radio cell for establishing the connectivity with the second radio cell.

Further, in some implementations, the first sidelink transmission grant from the second radio cell includes a Mode 1 sidelink transmission grant; the processor is configured to cause the apparatus to: receive sidelink resources via one or more of system information or dedicated RRC signaling; and transmit to the UE-to-network relay using the sidelink resources; the sidelink buffer status includes a data volume of one or more logical channels of the UE-to-network relay; the processor is configured to cause the apparatus to transmit data of at least one Uu application via the UE-to-network relay for receipt by the first radio cell; the processor is configured to cause the apparatus to determine that sidelink resources associated with the first radio cell and the second radio cell are concurrently usable for sidelink transmission; the processor is configured to cause the apparatus to: receive, from the first radio cell, a second sidelink transmission grant; transmit a first data type using the first sidelink transmission grant; and transmit a second data type using the second sidelink transmission grant; the processor is configured to cause the apparatus to: receive, from one or more of the UE-to-network relay or the second radio cell, reestablishment information indicating which of the first radio cell or the second radio cell is to be used for a connection reestablishment procedure; and implement, based at least in part on a reestablishment event, the connection reestablishment procedure based at least in part on the reestablishment information.

In a further example, the processor 904 and/or the transceiver 908 may support wireless communication at the device 902 in accordance with examples as disclosed herein. The processor 904 and/or the transceiver 908, for instance, may be configured as or otherwise support a means to establish connectivity with a first radio cell using an indirect path and via a user equipment UE-to-network relay, and connectivity with a second radio cell using a direct path; receive, from one or more of the UE-to-network relay or the second radio cell, reestablishment information indicating which of the first radio cell or the second radio cell is to be used for a connection reestablishment procedure; and implement, based at least in part on a reestablishment event, the connection reestablishment procedure based at least in part on the reestablishment information.

Further, in some implementations, the reestablishment event includes one or more of a radio link failure, a notification from the UE-to-network relay, or a unicast link release; to implement the connection reestablishment procedure, the processor is configured to cause the apparatus to: select, based at least in part on the reestablishment information, a reestablishment cell from the first radio cell and the second radio cell; and utilize, as part of the connection reestablishment procedure, credentials associated with the reestablishment cell; the credentials associated with the reestablishment cell include one or more of a C-RNTI of the reestablishment cell or a physical cell identity of the reestablishment cell.

The processor 904 of the device 902, such as a UE 104, may support wireless communication in accordance with examples as disclosed herein. The processor 904 includes at least one controller coupled with at least one memory, and the at least one controller is configured to and/or operable to cause the processor to establish connectivity with a first radio cell using an indirect path and via a UE-to-network relay, and connectivity with a second radio cell using a direct path; transmit, to the second radio cell, information pertaining to sidelink transmission to the first radio cell, the information comprising sidelink UE information and a sidelink buffer status; receive, from the second radio cell, a first sidelink transmission grant; and transmit, using the first sidelink transmission grant, sidelink data to the UE-to-network relay.

Further, the at least one controller is configured to cause the processor 904 to establish connectivity with a first radio cell using an indirect path and via a UE-to-network relay, and connectivity with a second radio cell using a direct path; receive, from one or more of the UE-to-network relay or the second radio cell, reestablishment information indicating which of the first radio cell or the second radio cell is to be used for a connection reestablishment procedure; and implement, based at least in part on a reestablishment event, the connection reestablishment procedure based at least in part on the reestablishment information. The at least one controller is further configured to cause the processor 904 to perform one or more other operations described herein such as with reference to a UE 104 and/or the device 902.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®), OS/2®, UNIX®, LINUX®, or another known operating system. In some implementations, the I/O controller 910 may be implemented as part of a processor, such as the processor M08. In some implementations, a user may interact with the device 902 via the I/O controller 910 or via hardware components controlled by the I/O

### Controller 910.

In some implementations, the device 902 may include a single antenna 912. However, in some other implementations, the device 902 may have more than one antenna 912 (e.g., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

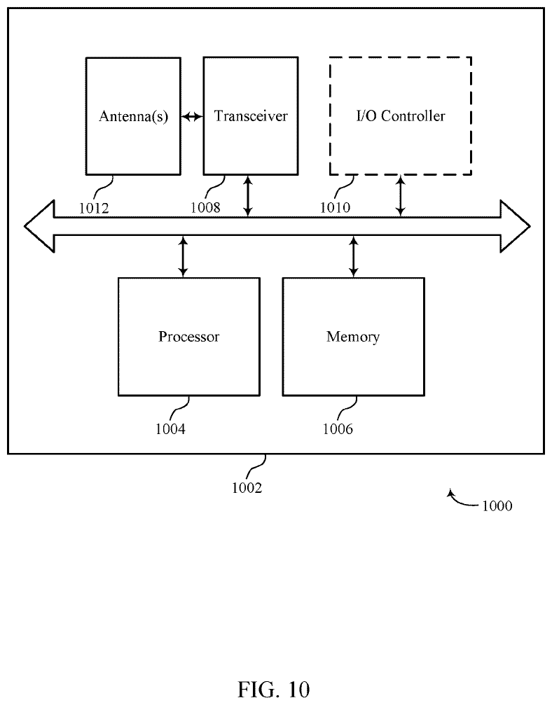

FIG. 10 illustrates an example of a block diagram 1000 of a device 1002 (e.g., an apparatus) that supports resource scheduling in multiple paths in accordance with aspects of the present disclosure. The device 1002 may be an example of a network entity 102 as described herein. The device 1002 may support wireless communication with one or more network entities 102, UEs 104, or any combination thereof. The device 1002 may include components for bi-directional communications including components for transmitting and receiving communications, such as a processor 1004, a memory 1006, a transceiver 1008, and an I/O controller 1010. These components may be in electronic communication or otherwise coupled (e.g., operatively, communicatively, functionally, electronically, electrically) via one or more interfaces (e.g., buses).

The processor 1004, the memory 1006, the transceiver 1008, or various combinations thereof or various components thereof may be examples of means for performing various aspects of the present disclosure as described herein. For example, the processor 1004, the memory 1006, the transceiver 1008, or various combinations or components thereof may support a method for performing one or more of the operations described herein.

In some implementations, the processor 1004, the memory 1006, the transceiver 1008, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1004 and the memory 1006 coupled with the processor 1004 may be configured to perform one or more of the functions described herein (e.g., executing, by the processor 1004, instructions stored in the memory 1006). In the context of network entity 102, for example, the transceiver 1008 and the processor 1004 coupled to the transceiver 1008 are configured to cause the network entity 102 to perform the various described operations and/or combinations thereof.

For example, the processor 1004 and/or the transceiver 1008 may support wireless communication at the device 1002 in accordance with examples as disclosed herein. For instance, the processor 1004 and/or the transceiver 1008 may be configured as or otherwise support a means to receive, at a first radio cell and from a first UE, information pertaining to sidelink transmission to a second radio cell, the information including sidelink UE information and a sidelink buffer status of the first UE; and transmit, to the first UE, a sidelink transmission grant including sidelink resources for sidelink transmission to the second radio cell.

Further, in some implementations, the sidelink transmission grant includes a Mode 1 sidelink transmission grant; the sidelink buffer status includes a data volume of one or more logical channels of a UE-to-network relay used by the first UE for transmission to the second radio cell.

The processor 1004 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1004 may be configured to operate a memory array using a memory controller. In some other implementations, a memory controller may be integrated into the processor 1004. The processor 1004 may be configured to execute computer-readable instructions stored in a memory (e.g., the memory 1006) to cause the device 1002 to perform various functions of the present disclosure.

The memory 1006 may include random access memory (RAM) and read-only memory (ROM). The memory 1006 may store computer-readable, computer-executable code including instructions that, when executed by the processor 1004 cause the device 1002 to perform various functions described herein. The code may be stored in a non-transitory computer-readable medium such as system memory or another type of memory. In some implementations, the code may not be directly executable by the processor 1004 but may cause a computer (e.g., when compiled and executed) to perform functions described herein. In some implementations, the memory 1006 may include, among other things, a basic I/O system (BIOS) which may control basic hardware or software operation such as the interaction with peripheral components or devices.

The I/O controller 1010 may manage input and output signals for the device 1002. The I/O controller 1010 may also manage peripherals not integrated into the device M02. In some implementations, the I/O controller 1010 may represent a physical connection or port to an external peripheral. In some implementations, the I/O controller 1010 may utilize an operating system such as iOS®, ANDROID®, MS-DOS®, MS-WINDOWS®, OS/2®, UNIX®, LINUX®, or another known operating system. In some implementations, the I/O controller 1010 may be implemented as part of a processor, such as the processor M06. In some implementations, a user may interact with the device 1002 via the I/O controller 1010 or via hardware components controlled by the I/O controller 1010.

In some implementations, the device 1002 may include a single antenna 1012. However, in some other implementations, the device 1002 may have more than one antenna 1012 (e.g., multiple antennas), including multiple antenna panels or antenna arrays, which may be capable of concurrently transmitting or receiving multiple wireless transmissions. The transceiver 1008 may communicate bi-directionally, via the one or more antennas 1012, wired, or wireless links as described herein. For example, the transceiver 1008 may represent a wireless transceiver and may communicate bi-directionally with another wireless transceiver. The transceiver 1008 may also include a modem to modulate the packets, to provide the modulated packets to one or more antennas 1012 for transmission, and to demodulate packets received from the one or more antennas 1012.

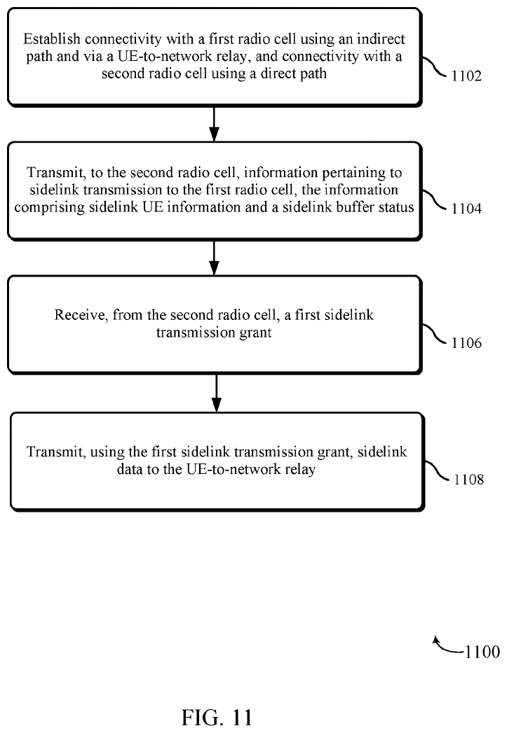

FIG. 11 illustrates a flowchart of a method 1100 that supports resource scheduling in multiple paths in accordance with aspects of the present disclosure. The operations of the method 1100 may be implemented by a device or its components as described herein. For example, the operations of the method 1100 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1102, the method may include establishing connectivity with a first radio cell using an indirect path and via a UE-to-network relay, and connectivity with a second radio cell using a direct path. The operations of 1102 may be performed in accordance with examples as described herein. In some implementations, aspects of the operations of 1102 may be performed by a device as described with reference to FIG. 1.

At 1104, the method may include transmitting, to the second radio cell, information pertaining to sidelink transmission to the first radio cell, the information comprising sidelink UE information and a sidelink buffer status. The operations of 1104 may be performed in accordance with examples as described herein. In some implementations, aspects of the operations of 1104 may be performed by a device as described with reference to FIG. 1.

At 1106, the method may include receiving, from the second radio cell, a first sidelink transmission grant. The operations of 1106 may be performed in accordance with examples as described herein. In some implementations, aspects of the operations of 1106 may be performed by a device as described with reference to FIG. 1.

At 1108, the method may include transmitting, using the first sidelink transmission grant, sidelink data to the UE-to-network relay. The operations of 1108 may be performed in accordance with examples as described herein. In some implementations, aspects of the operations of 1108 may be performed by a device as described with reference to FIG. 1.

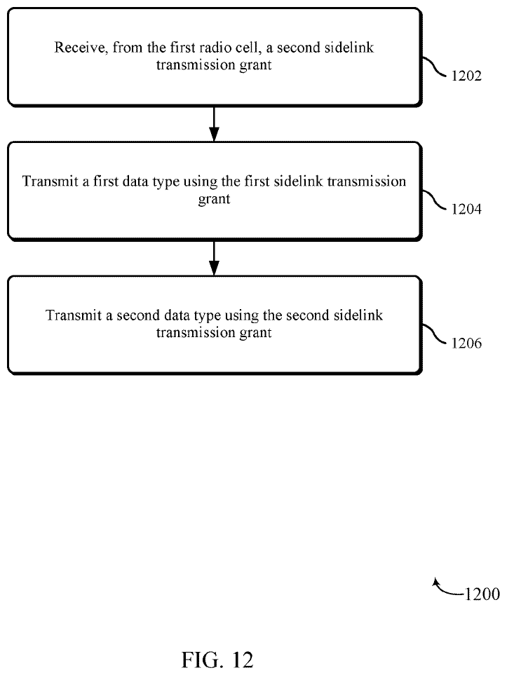

FIG. 12 illustrates a flowchart of a method 1200 that supports resource scheduling in multiple paths in accordance with aspects of the present disclosure. The operations of the method 1200 may be implemented by a device or its components as described herein. For example, the operations of the method 1200 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1202, the method may include receiving, from the first radio cell, a second sidelink transmission grant. The operations of 1202 may be performed in accordance with examples as described herein. In some implementations, aspects of the operations of 1202 may be performed by a device as described with reference to FIG. 1.

At 1204, the method may include transmitting a first data type using the first sidelink transmission grant. The operations of 1204 may be performed in accordance with examples as described herein. In some implementations, aspects of the operations of 1204 may be performed by a device as described with reference to FIG. 1.

At 1206, the method may include transmitting a second data type using the second sidelink transmission grant. The operations of 1206 may be performed in accordance with examples as described herein. In some implementations, aspects of the operations of 1206 may be performed by a device as described with reference to FIG. 1.

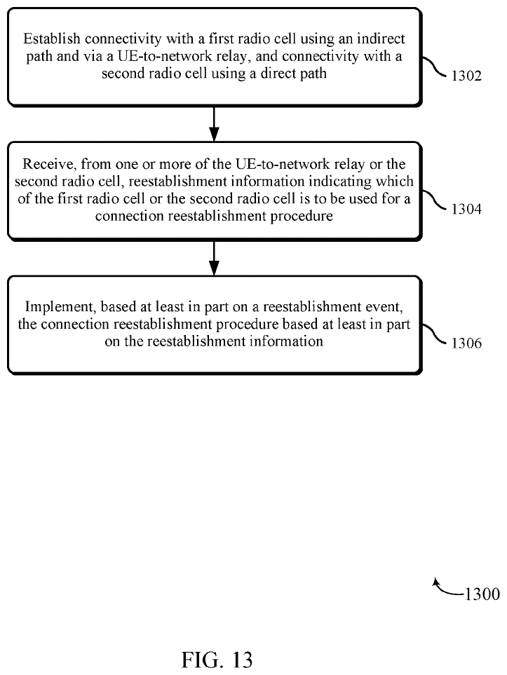

FIG. 13 illustrates a flowchart of a method 1300 that supports resource scheduling in multiple paths in accordance with aspects of the present disclosure. The operations of the method 1300 may be implemented by a device or its components as described herein. For example, the operations of the method 1300 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1302, the method may include establishing connectivity with a first radio cell using an indirect path and via a UE-to-network relay, and connectivity with a second radio cell using a direct path. The operations of 1302 may be performed in accordance with examples as described herein. In some implementations, aspects of the operations of 1302 may be performed by a device as described with reference to FIG. 1.

At 1304, the method may include receiving, from one or more of the UE-to-network relay or the second radio cell, reestablishment information indicating which of the first radio cell or the second radio cell is to be used for a connection reestablishment procedure. The operations of 1304 may be performed in accordance with examples as described herein. In some implementations, aspects of the operations of 1304 may be performed by a device as described with reference to FIG. 1.

At 1306, the method may include implementing, based at least in part on a reestablishment event, the connection reestablishment procedure based at least in part on the reestablishment information. The operations of 1306 may be performed in accordance with examples as described herein. In some implementations, aspects of the operations of 1306 may be performed by a device as described with reference to FIG. 1.

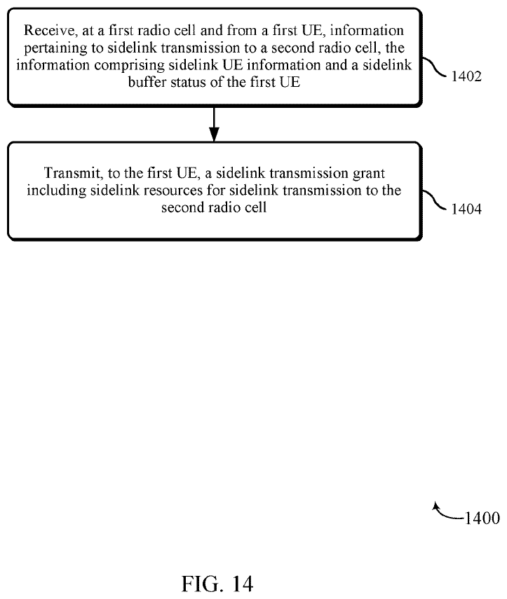

FIG. 14 illustrates a flowchart of a method 1400 that supports resource scheduling in multiple paths in accordance with aspects of the present disclosure. The operations of the method 1400 may be implemented by a device or its components as described herein. For example, the operations of the method 1400 may be performed by a network entity 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1402, the method may include receiving, at a first radio cell and from a first UE, information pertaining to sidelink transmission to a second radio cell, the information comprising sidelink UE information and a sidelink buffer status of the first UE. The operations of 1402 may be performed in accordance with examples as described herein. In some implementations, aspects of the operations of 1402 may be performed by a device as described with reference to FIG. 1.

At 1404, the method may include transmitting, to the first UE, a sidelink transmission grant including sidelink resources for sidelink transmission to the second radio cell. The operations of 1404 may be performed in accordance with examples as described herein. In some implementations, aspects of the operations of 1404 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
establish connectivity with a first radio cell using an indirect path and via a UE-to-network relay, and connectivity with a second radio cell using a direct path;
transmit, to the second radio cell, information pertaining to sidelink transmission to the first radio cell, the information comprising sidelink UE information and a sidelink buffer status;
receive, from the second radio cell, a first sidelink transmission grant; and
transmit, using the first sidelink transmission grant, sidelink data to the UE-to-network relay.

2. The UE of claim 1, wherein the at least one processor is operable to cause the UE to:
establish the connectivity with the first radio cell before the connectivity with the second radio cell; and
establish the connectivity with the second radio cell before the connectivity with the first radio cell.

3. The UE of claim 1, wherein to establish connectivity with the first radio cell, the at least one processor is operable to cause the UE to establish a radio resource control (RRC) connection with the first radio cell using the UE-to-network relay.

4. The UE of claim 1, wherein the at least one processor is operable to cause the UE to transmit to the UE-to-network relay using Mode 2 sidelink resources provided by the first radio cell.

5. The UE of claim 1, wherein the UE-to-network relay comprises a first sidelink destination, and wherein the at least one processor is operable to cause the UE to transmit to a second sidelink destination using Mode 2 resources provided by the first radio cell.

6. The UE of claim 1, wherein the at least one processor is operable to cause the UE to:
receive radio resource control (RRC) reconfiguration from the first radio cell configuring radio measurements for the UE; and
transmit, to the first radio cell, radio measurements based at least in part on the RRC reconfiguration.

7. The UE of claim 1, wherein to establish the connectivity with the second radio cell, the at least one processor is operable to cause the UE to receive radio resource control (RRC) reconfiguration from the first radio cell for establishing the connectivity with the second radio cell.

8. The UE of claim 1, wherein the first sidelink transmission grant from the second radio cell comprises a Mode 1 sidelink transmission grant.

9. The UE of claim 1, wherein the at least one processor is operable to cause the UE to:
receive sidelink resources via one or more of system information or dedicated radio resource control (RRC) signaling; and
transmit to the UE-to-network relay using the sidelink resources.

10. The UE of claim 1, wherein the sidelink buffer status comprises a data volume of one or more logical channels of the UE-to-network relay.

11. The UE of claim 1, wherein the at least one processor is operable to cause the UE to transmit data of at least one Uu application via the UE-to-network relay for receipt by the first radio cell.

12. The UE of claim 1, wherein the at least one processor is operable to cause the UE to determine that sidelink resources associated with the first radio cell and the second radio cell are concurrently usable for sidelink transmission.

13. The UE of claim 1, wherein the at least one processor is operable to cause the UE to:
receive, from the first radio cell, a second sidelink transmission grant;
transmit a first data type using the first sidelink transmission grant; and
transmit a second data type using the second sidelink transmission grant.

14. The UE of claim 1, wherein the at least one processor is operable to cause the UE to:
receive, from one or more of the UE-to-network relay or the second radio cell, reestablishment information indicating which of the first radio cell or the second radio cell is to be used for a connection reestablishment procedure; and
implement, based at least in part on a reestablishment event, the connection reestablishment procedure based at least in part on the reestablishment information.

15. (Canceled)

16. (canceled)

17. (canceled)

18. (canceled)

19. A user equipment (UE) for wireless communication, comprising:
at least one memory; and
at least one processor coupled with the at least one memory and operable to cause the UE to:
establish connectivity with a first radio cell using an indirect path and via a UE-to-network relay, and connectivity with a second radio cell using a direct path;
receive, from one or more of the UE-to-network relay or the second radio cell, reestablishment information indicating which of the first radio cell or the second radio cell is to be used for a connection reestablishment procedure; and
implement, based at least in part on a reestablishment event, the connection reestablishment procedure based at least in part on the reestablishment information.

20. A method, comprising:
establishing connectivity with a first radio cell using an indirect path and via a user equipment (UE)-to-network relay, and connectivity with a second radio cell using a direct path;
transmitting, to the second radio cell, information pertaining to sidelink transmission to the first radio cell, the information comprising sidelink UE information and a sidelink buffer status;
receiving, from the second radio cell, a first sidelink transmission grant; and
transmitting, using the first sidelink transmission grant, sidelink data to the UE-to-network relay.

21. The method of claim 20, further comprising:
establishing the connectivity with the first radio cell before the connectivity with the second radio cell; and
establishing the connectivity with the second radio cell before the connectivity with the first radio cell.

22. The method of claim 20, wherein establishing connectivity with the first radio cell comprises establishing a radio resource control (RRC) connection with the first radio cell using the UE-to-network relay.

23. The method of claim 20, further comprising transmitting to the UE-to-network relay using Mode 2 sidelink resources provided by the first radio cell.

24. A method, comprising:
establishing connectivity with a first radio cell using an indirect path and via a user equipment (UE)-to-network relay, and connectivity with a second radio cell using a direct path;
receiving from one or more of the UE-to-network relay or the second radio cell, reestablishment information indicating which of the first radio cell or the second radio cell is to be used for a connection reestablishment procedure; and
implementing, based at least in part on a reestablishment event, the connection reestablishment procedure based at least in part on the reestablishment information.
